(19) United States
(12) Patent Application Publication
(10) Pub. No.: US 2005/0231322 A1
(43) Pub. Date: Oct. 20, 2005

(54) Contact plate apparatus for determining the position of a joystick

(76) Inventor: Chi Ming Fong, Tal Po (HK)

Correspondence Address: GREENBERG TRAURIG, LLP, 77 WEST WACKER DRIVE, SUITE 2500, CHICAGO, IL, 60601-1732, US

(21) Appl. No.: 10/967,452

(22) Filed: Oct. 18, 2004

Related U.S. Application Data
(60) Provisional application No. 60/512,175, filed on Oct. 17, 2003.

(51) Int. Cl. H01C 10/10

(52) U.S. Cl. 338/162; 338/47

(57) ABSTRACT

A user input device, such as a joystick, includes a wiper and a contact plate imprinted upon a printed circuit card. An arm, movable about at least one axis of motion is provided. Movement of the arm about an axis imparts relative movement between an associated wiper and the contact plate. The contact plate includes a plurality of conductive sub-regions. The relative movement of the wiper and the contact plate causes the wiper to sequentially form electrical contact with an individual sub-region, then two adjacent sub-regions, then an individual sub-region, comprising the other of the two adjacent sub-region. A microprocessor decodes an encoded pattern output generated by leads operably attached to the conductive sub-regions.

This application claims priority of the filing date of U.S. Ser. No. 60/512,175.

### BACKGROUND OF THE INVENTION

1. Field of the Invention

The present invention relates, in general, to user input devices such as joysticks, and, more particularly, to arrangements for contact plates used within joysticks for determining the current position of a joystick.

2. The Prior Art

The conventional joystick design incorporates a substantially vertical shaft emanating upward from a housing base. The shaft may be capped with a knob to facilitate grasping and movement by a user. Such a joystick is typically provided for use with a microprocessor based electronic device such as a personal computer or video game console. The joystick is further electrically connected to the electronic device by a wire, though wireless joysticks also exist.

Such user input devices are often used to manipulate the position of a cursor on a video display under the control of the microprocessor based device. The joystick device may also be used to control the operation of a game or program such as is the case in a flight simulator program where the joystick may control the movement of a simulated aircraft.

The joystick is capable of moving up, down, left and right and all points therebetween. Movement is of course triggered by physical force exerted by a user which causes the joystick shaft to deflect from its normal or neutral position, typically centered.

To detect the position of the joystick the prior art teaches the use of an overlapping bracket or frame structure which is offset from its normal or neutral position upon movement of the shaft which passed through or is otherwise connected to the bracket or frame. Typically one bracket or frame is provided for each of the x-axis and y-axis. An example of a typical construction may be found in U.S. Pat. No. 6,307,486 and U.S. Pat. No. 4,148,014, and the disclosures of both of these patents is incorporated by reference herein. As can be seen, movement in either the x-axis or y-axis causes the bracket or frame to rotate on its bearing which movement is detected by a sensor. The degree to which one, the other or both frame members move is detected and serves to indicate the relative position of the joystick and ultimately controls the movement and position of the cursor on the display.

The prior art teaches various forms of sensors. One common form is a potentiometer or variable resistor device. A potentiometer is connected to the end of the bracket. Alternatively, the potentiometer may be connected to a geared linkage which in turn connects to the bracket. Movement of the bracket translates into movement of the potentiometer. The varying resistance is then detected and the position of the joystick is determined using a voltage comparison circuit. Such a joystick is commonly referred to as an analog joystick because the resistive values must be measured and ultimately converted into a digital signal for use by a microprocessor based device. The prior art also disclosures the use of photo sensors where a slotted wheel or disk connected to the bracket moves and breaks a beam of light. A photo sensor detects the interruptions in the otherwise constant beam of light to determine movement and direction.

### SUMMARY OF THE INVENTION

The present invention comprises an apparatus for determining the position of a joystick, including at least one wiper, or wiper member. At least one contact member, such as a contact plate of a printed circuit card, having at least two conductive sub-regions of a conductive region, including a first sub-region and a second sub-region, is provided. An arm movable about at least one axis, such as the user-movable control of a joystick is provided and operably attached to at least one of a wiper member and an associated contact member, such that movement of the arm about one axis imparts relative movement of a wiper member and an associated contact member, such that the wiper member is sequentially in electrical contact with only the first sub-region, then both the first sub-region and the second sub-region, and then only the second sub-region.

In a preferred embodiment, the contact member further includes a common conductive region which is in continuous electrical contact with the wiper member. A conductive lead operably connects at least one of the sub-regions to an input port of a microprocessor. Moreover, in a preferred embodiment, a plurality of conductive leads are provided, each conductive lead operably connecting an associated conductive sub-region to the input port of the microprocessor. Another conductive lead operably connects the common conductive region to an input port of a microprocessor.

Further, in a preferred embodiment, at least one contact member includes a plurality of conductive regions, and each of the conductive regions includes a plurality of conductive sub-regions. In particular, at least one of the conductive regions may include four conductive sub-regions. At least one contact member further includes a nonconductive region disposed between two conductive regions. This nonconductive region is indicative of an upright, neutral, or common position of the arm.

Moreover, in a preferred embodiment, the user input device includes at least two wiper members and at least two contact members.

### BRIEF DESCRIPTION OF THE DRAWINGS

FIG. 1 is a simplified diagram of a printed circuit card of a joystick contact plate in accordance with the present invention;

FIG. 2 is a diagram illustrating the various left, right, up, and down positions that the present joystick can assume; and

FIG. 3 is an enlarged, simplified diagram of the printed circuit card of FIG. 1 and showing, in particular, the individual elements of each contact region.

### DETAILED DESCRIPTION OF THE DRAWINGS

While this invention is susceptible to embodiment in many different forms, there are shown in the drawings and will herein be described in detail, certain specific embodiments with the understanding that the present disclosure should be considered as an exemplification of the principles of the invention and is not intended to limit the invention to the embodiments so illustrated.

The present invention discloses a form of a digital joystick and in particular a contact plate which forms a portion of the sensor of the digital joystick. One related form of such a device is disclosed in U.S. Pat. No. 4,148,014, the disclosure of which is incorporated by reference herein.

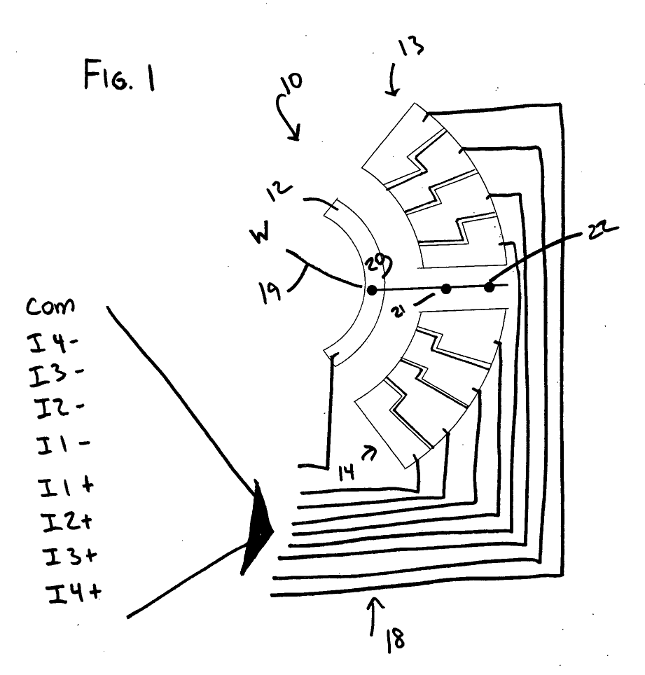

The present disclosure is made with reference to FIGS. 1, 2 and 3. FIG. 1 illustrates the contact plate portion of the present invention.

The joystick shaft or bar can be moved independently in either the x-axis or y-axis.

The contact plate 10 comprises a printed circuit board 11, the surface of which has formed thereon three electrical contact regions in specific discrete shapes. When the joystick is at rest in its vertical position, it is deemed to be in its neutral position. (Most joysticks incorporate some form of a return mechanism, such as a spring which biases the joystick shaft into its neutral position.)

The contact surfaces comprise a first continuous generally arc shaped contact region 12. Adjacent and in the same general arc are an upper arc shaped contact region 13 and a lower arc shaped contact region 14. Each of the upper and lower contact regions are subdivided into 4 separate contact sub-regions 13a-13d and 14a-14d. Each of the common and eight other contact sub-regions are connected to wires or leads 18 which are, in turn, connected to the present joystick device's microprocessor input/output circuit, not shown.

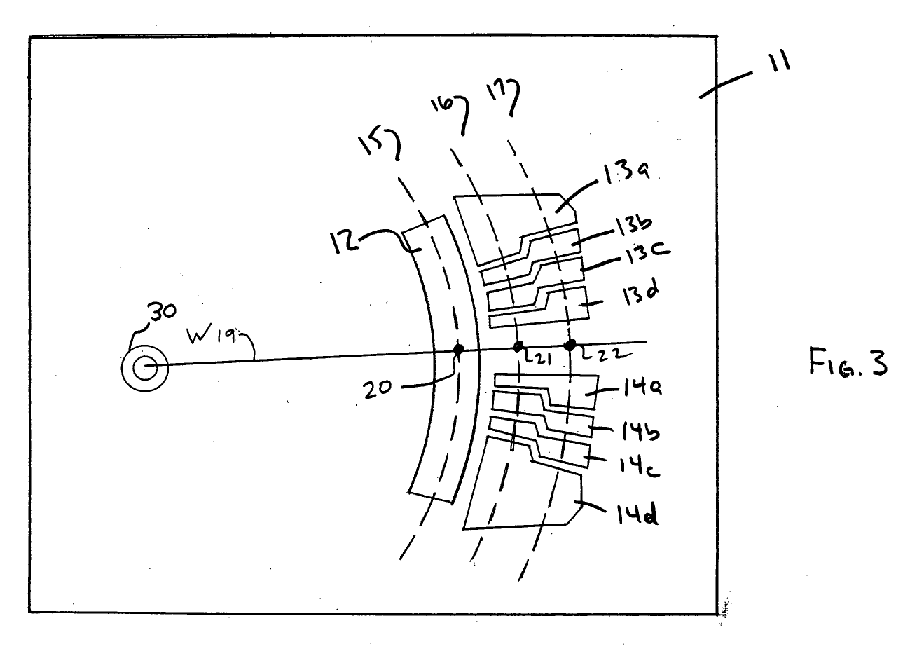

A wiper arm 19 having three metal contact points 20, 21 and 22 is affixed to the moveable bracket or frame structure for each of the x-axis and y-axis of the joystick. A contact plate of the form illustrated is affixed in a stationary position and in abutment with each wiper arm. Accordingly, two contact plates of the type depicted in FIGS. 1 and 3 are employed in the joystick of the present invention, with one contact plate employed to detect position, or movement of the joystick about the x-axis, and the other contact plate employed to detect position, or movement of the joystick about the y-axis.

Although, in the illustrated embodiment, the wiper arm is movable and the contact plates, and their associated circuit cards are stationary, it is also contemplated that the contact plates, and their associated circuit cards, may be movably affixed to the bracket or frame structure for each axis of the joystick, relative to fixed associated wiper, or contact arm.

The wiper arm is illustrated schematically and designated with the letter “W” and number 19. Each of the three contact points carried on the wiper arm are designated by a circular symbol 20-22. The wiper travels in an arc which is concentric with the arc shaped contact regions. The paths of the wiper and its three contact points are designated 15-17. Movement of the wiper and its three contact points is specifically illustrated in FIG. 3. As shown in FIG. 3, circuit card 11 may further include an aperture 30, through which a pivot of the wiper arm may be disposed.

Accordingly, when the joystick is moved in the direction of the x-axis, the metal contacts on the wiper arm move in contact with the printed circuit board (PCB) contact plate. The specific layout of the contact plate serves to determine the relative position of the joystick. A digital signal is thus generated within wires or leads 18 which is used by the microprocessor to determine the degree to which the joystick shaft has been moved.

The relative position thus generates a “code” which corresponds to the position of each axis of the joystick. The use of such an encoding scheme, and such a configuration of interlocking, or overlapping sub-regions of the contact plate allows a finer positioning of the joystick arm to be detected, with one half of the conductors, and one half of the required associated required microprocessor inputs, as compared to the use of individual, non-overlapping and more finely pitched sub-region conductors on the contact plate. One advantage of a digital joystick over an analog joystick is the ability to omit the use of an analog to digital converter or voltage comparator or other optical device. All that is needed is to connect the output of the joystick contact place to an input port.

When the wiper 19 is moved across the contact regions one or two of the inputs from contact points 21 and 22 will be on the same level as the common contact region, and in electrical contact with the contact points of the wiper arm. For example, referring to FIG. 3, movement of the joystick along one axis will cause the following alternating sequence of individual and dual contacts to sequentially occur: (I1+, I1+/I2+, I2+, I2+/I3, I3+, I3+/I4+, I4+).

The microprocessor will determine which contact regions are active based upon the position of the wiper relative to the common region and any of the sub-regions of the upper and lower arc contact surfaces. In one axis, the associated upper region designates movement upward, and the lower region, downward. In the other axis, the upper region designates movement to the left and the other to the right. For each axis, the microprocessor will periodically poll the I4−, I3−, I2−, I1−, I1+, I2+, I3+ and I4+ inputs, detecting which, at any given point in time, are in electrical contact with the Com, or common conductor. This, in turn, will provide an indication of the instantaneous position of the joystick's vertical shaft.

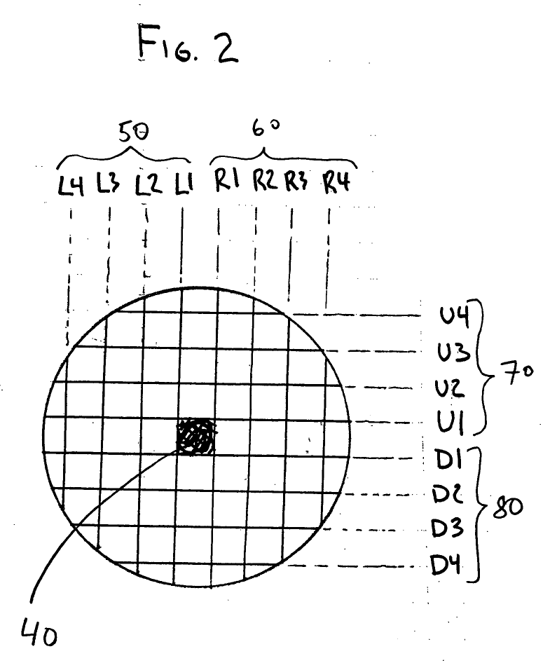

The diagram of FIG. 2 illustrates the available possible positions which can be assumed by the joystick. When the joystick is at rest at its normal/neutral position, the contact plate will contact the central shaded area 40 that has no contact at all. When the joystick moves, the contact will move within the area of the circle and generate a combination of Lx/Ux, Lx/Dx, Rx/Ux; Rx/Ux where L stand for left, R for right, U for up and D for down. Although, in the illustration of FIG. 2, there are four left contacts 50, four right contacts 60, four up contacts 70 and four up contacts 80, a greater or lesser number of contacts, and associated contact sub-regions of FIGS. 1 and 3, may alternatively be employed.

As shown in FIG. 3, there are three regions on the contact plate. One is a common point 20 and the other two are input plates 21 and 22. The printed circuit board (PCB) is located at an intersecting position and therefore even when one of the input plates contacts a boundary between two sub-regions the other contact plate is still in contact with one of the contact points carried on the wiper arm. When neither of the input contact points are in contact with the contact region the microprocessor considers the joystick shaft to be in its neutral position.

The foregoing description and drawings merely explain and illustrate the invention, and the invention is not so limited, as those skilled in the art who have the disclosure before them will be able to make modifications and variations therein without departing from the scope of the invention.

1. An apparatus for determining the position of a joystick, comprising:
at least one wiper member;
at least one contact member having at least two conductive sub-regions including a first sub-region and a second sub-region;
an arm movable about at least one axis; and
an arm movable in at least one axis of motion and operably attached to at least one of a wiper member and an associated contact member, such that movement of the arm about one axis imparts relative movement of a wiper member and an associated contact member, such that the wiper member is sequentially in electrical contact with only the first sub-region, then both the first sub-region and the second sub-region, and then only the second sub-region.

2. The invention according to claim 1, wherein the contact member further includes a common conductive region which is in continuous electrical contact with the wiper member.

3. The invention according to claim 1, further comprising a conductive lead operably connecting at least one of the sub-regions to an input port of a microprocessor.

4. The invention according to claim 1, further comprising a plurality of conductive leads, each conductive lead operably connecting an associated conductive sub-region to an input port of a microprocessor.

5. The invention according to claim 2, further comprising a conductive lead operably connecting the common conductive region to an input port of a microprocessor.

6. The invention according to claim 1, wherein at least one contact member includes a plurality of conductive regions, and each of the conductive regions includes a plurality of conductive sub-regions.

7. The invention according to claim 6, wherein at least one of the conductive regions includes four conductive sub-regions.

8. The invention according to claim 7, wherein the four conductive sub-regions includes a first conductive sub-region, a second conductive sub-region, a third conductive sub-region, and a fourth conductive sub-region, and movement of the arm about one axis causes the wiper member to sequentially be in electrical contact with only the first sub-region, then both the first sub-region and the second sub-region, then only the second sub-region, then both the second sub-region and the third sub-region, then only the third sub-region, then both the third sub-region and the fourth sub-region, and then only the fourth sub-region.

9. The invention according to claim 6, wherein at least one contact member further includes a nonconductive region disposed between two conductive regions.

10. The invention according to claim 9, wherein the nonconductive region is indicative of a neutral position of the arm.

11. The invention according to claim 1, wherein the user input device includes at least two wiper members and at least two contact members.
